(19) United States
(12) Patent Application Publication
(10) Pub. No.: US 2018/0197248 A1
(43) Pub. Date: Jul. 12, 2018

(54) SELF-LEARNING SYSTEM AND METHOD FOR SUCCESSIVELY PROVIDING FINANCIAL INFORMATION FOR REVIEW AND SCORING

(71) Applicant: WIZLIST LLC, NEW YORK, NY (US)

(72) Inventor: KENNETH VAUGHAN, NEW YORK, NY (US)

(73) Assignee: WIZLIST LLC, NEW YORK, NY (US)

(21) Appl. No.: 15/914,199

(22) Filed: Mar. 7, 2018

Related U.S. Application Data
(63) Continuation of application No. 13/852,415, filed on Mar. 28, 2013, now abandoned.
(60) Provisional application No. 61/764,184, filed on Feb. 13, 2013.

(51) Int. Cl. G06Q 40/06

(52) U.S. Cl. CPC G06Q 40/06

(57) ABSTRACT

A system that facilitates self-learning by a user can communicate information over a network. The system has a local user interface and a user interface generator that can present a request for the user to identify a target security. The system can step through a number of financial categories and present: (i) information about each financial category, and (ii) a request for a user to choose a score for this category. The system can calculate an overall score for the target security based on the categorical scores.

### CROSS-REFERENCES TO RELATED APPLICATIONS

This application claims the benefit of U.S. Provisional Patent Application, Ser. No. 61/764,184, filed 13 Feb. 2013, the contents of which are hereby incorporated by reference herein.

### BACKGROUND OF THE INVENTION

### 1. Field of the Invention

The present invention relates to systems and methods for providing financial information and educational guidance, and in particular, to systems providing a programmed progression through a number of financial categories in order to refine financial decisions.

### 2. Description of Related Art

Understanding and predicting changes in the value of securities is notoriously difficult. As used herein, the term securities includes stocks, bonds, treasuries, mutual funds, derivatives, futures, puts, calls, commodities, money market funds, and any other instrument, product or device that may serve as an investment, either foreign or domestic.

Some investors rely on the advice of a stockbroker or subscribe to a financial newsletter that forecasts market trends. Some investors will rely on the ratings of established agencies such as Moody's, Standard & Poor's, etc. Certain financial institutions will also publish advice on specific securities giving them a buy, hold, or sell rating. Various online services (e.g. MorningStar) will also rate various securities.

Still, relying on the advice of others can be unsatisfying because the advice may conflict from adviser to adviser. Also, investors would normally like to develop a better understanding of the mechanics of rating an investment in order to increase their confidence when making an investment decision.

An enormous number of publications can be found describing techniques and strategies for picking stocks and other securities Even if an investor is prepared to devote the considerable amount of time needed to study these publications, placing this bookish knowledge into practice is difficult. For example, while an investor may read about “price to sales ratio” and “price to earnings ratio,” as well as other financial criteria, these concepts can be easily confused and their importance forgotten or misjudged.

Also, an investor may be overwhelmed by the need to gather and study a wide variety of statistics on an investment. Juggling all of these statistical facts can cause confusion and often the investor cannot perceive the “big picture” on the quality of the target investment. For this reason, an investor will often focus on just a few criteria in order to keep the analysis manageable, even though this cribbed view will diminish the accuracy of the analysis. Still, when an investor restricts the analysis to a handful of criteria, there is no assurance that the selected criteria are important fundamentals, as opposed to be less important, secondary considerations.

See also, U.S. Pat. Nos. 5,999,918; 7,624,069; 7,765,138; and 8,275,690, as well as US Patent Application Publication Nos. 2005/0251475; 2006/0026056; 2006/0167772; 2007/0067180; 2008/0255862; and 2009/0106236.

### SUMMARY OF THE INVENTION

In accordance with the illustrative embodiments demonstrating features and advantages of the present invention, there is provided a system for facilitating self-learning by a user. The system includes a user interface generator that presents a request for the user to identify a target security. The user interface generator also successively presents for a plurality of financial categories: (i) information about successive ones of the plurality of financial categories, and (ii) a request for a user to choose for successive ones of the plurality of categories a plurality of categorical scores. The user interface generator includes a processing engine for calculating an overall score for the target security based on the plurality of categorical scores

In accordance with another aspect of the invention, there is provided a system for facilitating self-learning by a user and for exchanging information over a network. The system includes a local user interface operable to allow user selection of a target security. The system also has a processing arrangement including a common server and local processor both coupled to the network. The local processor is connected to the local user interface. The processing arrangement is operable to transmit for display at the local user interface successive screens regarding a plurality of categories of analytic information. The successive screens present successive scoring requests in order to assemble a plurality of categorical scores for the plurality of categories. The processing arrangement is operable to calculate for display at the local user interface an overall score for the target security based on the plurality of categorical scores.

In accordance with another aspect of the present invention, a method is provided for facilitating self-learning by a user. The method employs a user interface with display. The method includes the step of allowing user selection of a target security through the user interface. Another step is displaying on the display successive screens regarding a successive plurality of categories of analytic information. The successive screens each have information about a current one of the plurality categories. The method also includes the step of accepting through the user interface for the plurality categories a plurality of categorical scores. Another step is calculating and displaying on the display an overall score for the target security based on the plurality of categorical scores.

By employing systems and methods of the foregoing type, an improved technology is achieved for providing financial information and for facilitating self-learning regarding investment decisions.

The disclosed system calculates an investment confidence score by evenly weighing, or unevenly weighing, the specific financial metrics based on user inputted confidence ratings for each individual metric/criteria. Scores are then saved to a user profile. Real-time financial statistics, industry specific ads, an interactive dashboard, and a community section, allows members to perform research, calculate and vet their scores.

In a disclosed embodiment, a browser running on a user's computer can access a common server. The user can gain limited access to the server as a guest or can register to obtain additional services as a registered user.

Initially, a user will identify an investment, e.g. a publicly traded stock, by presenting the ticker symbol or company name (in some cases a partial or misspelled name or symbol). The common server will decipher the name or symbol presented by the user and will transmit the most likely names, ticker symbols. Thereafter the system will provide additional information as described below. At this initial stage, the user must decide whether to analyze the selected investment using a shortened or a comprehensive list of considerations.

Thereafter, the user steps programmatically through a succession of screens that provide information on successive financial topics (that is, on categories of analytical information on a financial topic). For example, the first screen may concern market capitalization and include a short synopsis of the meaning and usefulness of this category of financial information. This synopsis can also include links to sources that can provide further details on this topic in general, or on pertinent statistics that apply to this selected investment.

The screen may also offer timely financial information from a financial news server. For example, recent news about the investment or public statements by the issuing company may be presented at the top of the screen as headlines/links. Also the screen may include a chart showing the fluctuations of the stock price over a period of time. In addition, this screen may include market statistics; for example, range of stock prices, volume, price to earnings ratio, etc.

This disclosed screen will also include a virtual slider allowing the user to set the user's confidence in the quality of this investment with respect to the category of financial information being discussed on this screen (in this first screen, market capitalization). The slider can be set using, for example, a mouse or keyboard, anywhere between 0% to 99% depending upon the user's impressions drawn from this page. The confidence score just set by the user will then be used to update a list of scores in a separate panel on this screen. On the other hand, the user may skip to the next screen without scoring, in which case the confidence score will be set at a default value, for example 50%.

In any event, the user may progress through a series of screens of this type, setting a confidence level for the category presented at each screen. At any time in the succession of screens, or preferably when all of the screens have been reviewed and scored, the overall score results will be presented on a separate screen together with a panel listing all of the individual confidence scores. The overall score may be a simple average, a weighted average, or some other multivariable function. However, before presenting any overall scores, the user must acknowledge a disclaimer stating that the software is educational and that the user takes full responsibility for any investment decisions.

As noted above, the user can choose a shortened or comprehensive list of criteria and can finish one list before starting the other list. If two different lists have been finished, overall score results for both lists are presented side-by-side.

Ordinarily, a user will have analyzed a number of different securities. The results of these analyses can be reviewed on a summary page that lists all securities that have been analyzed. This page will list for each security the overall score achieved using the shortened and the comprehensive list of criteria. This page will also provide the average score reported for this security by other users that are using this service and have stored their overall scores on the common server.

### BRIEF DESCRIPTION OF THE DRAWINGS

The above brief description as well as other objects, features and advantages of the present invention will be more fully appreciated by reference to the following detailed description of illustrative embodiments in accordance with the present invention when taken in conjunction with the accompanying drawings, wherein:

FIG. 1 is a schematic diagram of system implementing a method, all in accordance with principles of the present invention;

FIG. 2 is a flow chart associated with the system of FIG. 1;

FIG. 3 is an illustration of one of a plurality of successive screens displayed by the system of FIG. 1;

FIG. 4 is an illustration of another screen displayed by the system of FIG. 1; and

FIG. 5 is an illustration of still another screen displayed by the system of FIG. 1.

### DETAILED DESCRIPTION

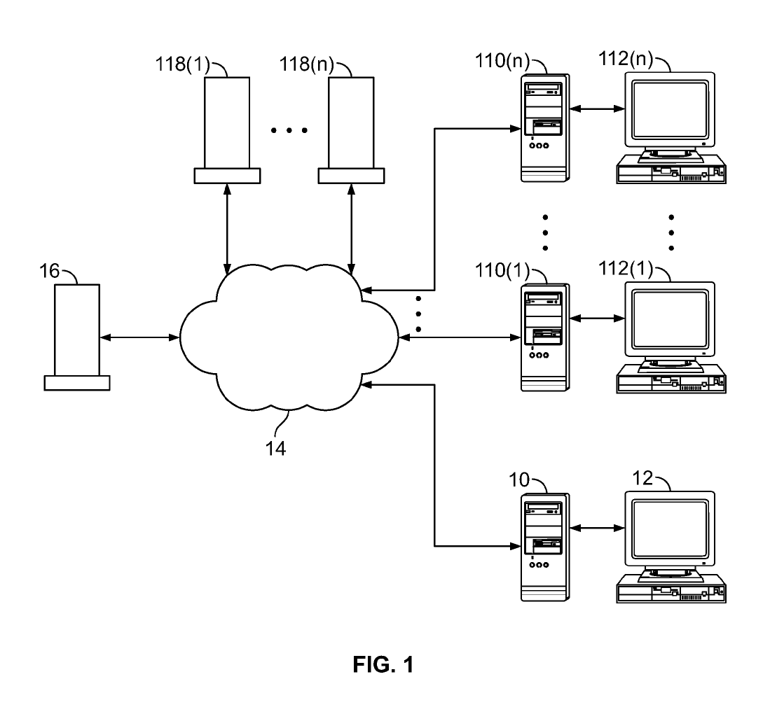

Referring to FIG. 1, the illustrated system employs a local processor 10, which has its own internal memory. Processor 10 may be a personal computer, microcomputer, personal digital assistant (PDA), smart phone, minicomputer or mainframe computer.

In this embodiment local user interface 12 comprises a display (monitor), keyboard and optional mouse. In other embodiments the interface may employ a touchscreen that can be used as a pointing device and can also display a virtual keyboard. In still other embodiments the user interface may include audio speakers cooperating with a speech synthesizer, as well as a microphone cooperating with speech recognition software.

Processor 10 is shown communicating over network 14, which may be the Internet, a virtual private network, local area network, a wide area network, or other type of network. This network communication will include two-way communications with common server 16, which is considered a processing engine and shall be described in further detail herein.

A number of financial news servers 118(1) through 118(n) are also connected to network 14. In this embodiment news servers 118(1) through 118(n) communicate with common server 16 but in other embodiments may communicate directly to local processor 10 and remote processors 110(1) through 110(n). In this specification processor 10 and the servers 16 and 118(1) through 118(n), operating over network 14, will be referred to as a processing arrangement (or user interface generator).

Also connected to network 14 are a number of remote interfaces, shown as processors 110(1) through 110(n) with respective user interfaces/displays 112(1) through 112(n). Remote processors 110(1) through 110(n) and user interfaces/displays 112(1) through 112(n) need not be identical and may employ any one of various hardware devices previously described in connection with local processor 10 and user interface 12. Remote processors 110(1) through 110(n) can communicate with common server 16 in a manner similar to the communications accomplished by local processor 10.

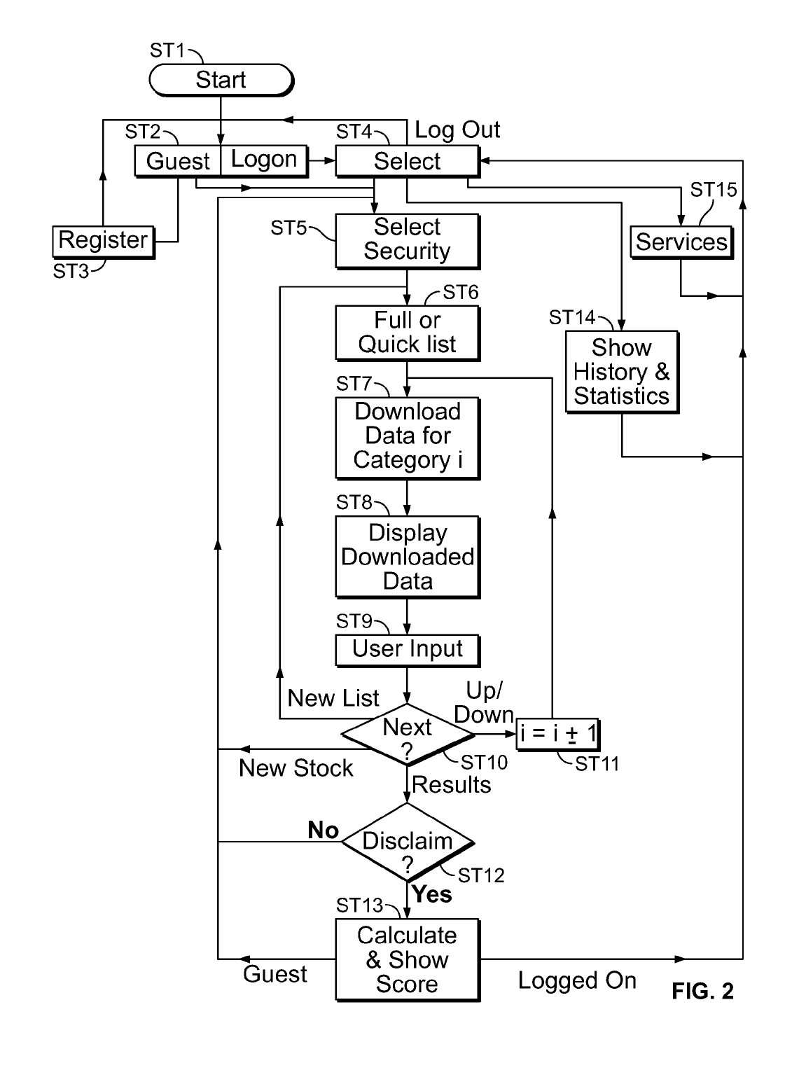

Referring to FIGS. 1-3, the flowchart of FIG. 2 represents software that is running on common server 16 of FIG. 1. In this embodiment common server 16 operates as a web server that interacts with a browser running on local processor 10. Accordingly, local processor 10 need not run specialized software. However in some embodiments, specialized software may in fact be running on local processor 10, in which case common server 16 will simply provide the information specifically requested by processor 10.

In still other embodiments processor 10 will store all information needed to perform the steps illustrated in the flowchart of FIG. 2. Nevertheless, the information stored at the local processor may need to be updated in any one of various ways; such as scheduled downloads of information from a dedicated FTP server or an independent third party web site. In other cases the update may be performed by physically delivering media having the update information.

After the initializing step ST1 of FIG. 2, server 16 will wait in step ST2 for visitors such as the user of processor 10 to access the server's home page. An unregistered visitor may proceed as a guest to step ST5, which will be described later hereinafter. Alternatively a user who has registered in step ST3 can logon using a password at any time and proceed to the selection step ST4 where the user will be given the choice of implementing step ST5, ST14 or ST15, which steps will be described presently.

Assuming for now the user selects step ST5, server 16 will present to the user a dialog box to allow the user to specify a target security. In this embodiment the securities will be publicly traded stocks, although other types of securities can be handled, and therefore the term “security” will be broadly defined as indicated above. The user can create a query in the dialog box by entering either the ticker symbol or the name of the company that issued the stock. The user can enter a partial company name and server 16 will reply by providing a drop-down list with potential matches for the user to select. These potential matches will accommodate misspellings by the user. The system will operate in a similar fashion for entry of ticker symbols. The system will correlate company names and ticker symbols for the user.

Once a security has been selected, a user will then be able to choose in step ST6 either a full list or a shortened (quick) list. As explained further hereinafter, the chosen list size (list length) will determine how many, and which categories of financial information/data will be later presented to the user. The chosen list size determines which categories will be presented based on preprogrammed rules. If the full list is selected all categories will be presented; if the shortened list, a smaller subset. While a binary choice was just described, in other embodiments, more than two choices may be offered.

Thereafter, in step ST7 server 16 will obtain information relative to the security (company) chosen in step ST5. This information will be obtained from one or more of the financial news servers 118(1) through 118(n) over network 14, although in some instances the information may be obtained from server 16 itself. This information may be presented in step ST8 as a web page delivered over network 14 to processor 10 for display on user interface 12.

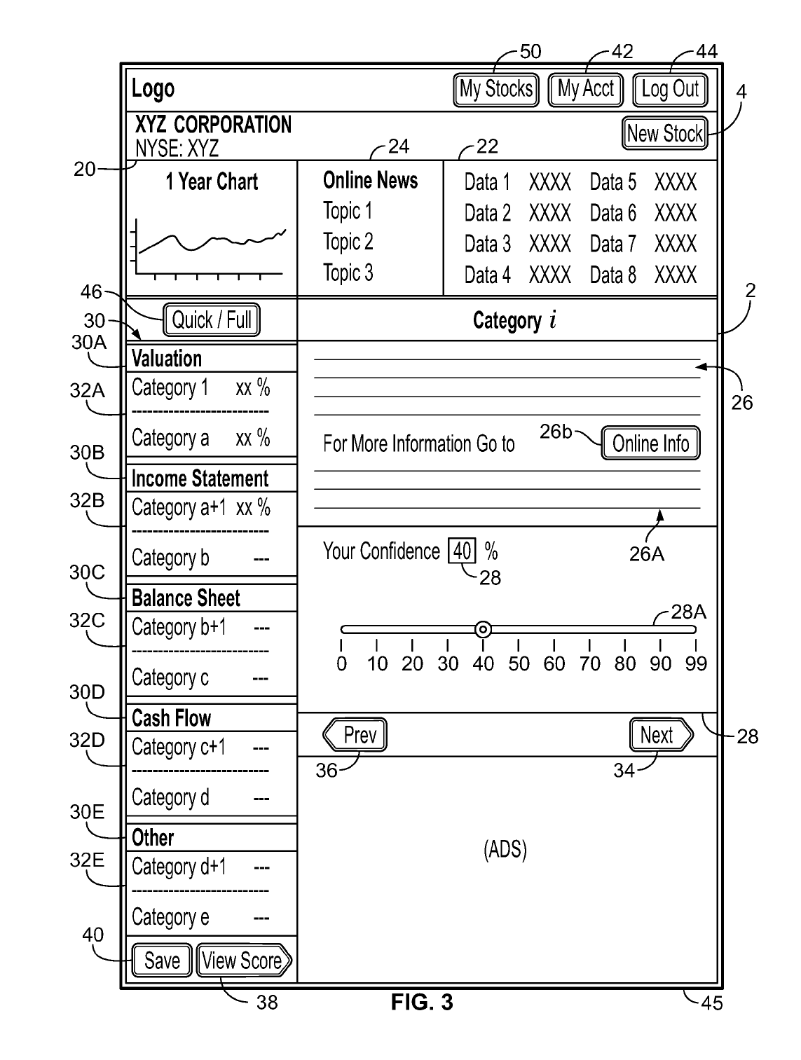

An example of such a web page is shown in the screen of FIG. 3 for the target security, the fictitious “XYZ Corporation” (fictitious New York Stock Exchange ticker symbol “XYZ”). Information originating from the financial news server (i.e., one or more of the servers 118(1) through 118(n)) is displayed in panels 20, 22 and 24. For example, panel 20 is a chart showing stock prices over a one year period for the hypothetical security.

Panel 22 is shown listing eight data items, although a different number may be displayed in other embodiments. Again, it will be understood that the data are illustrated symbolically and in an actual embodiment will appear as a tagged number(s), such as “52 Week 4.79-7.73.” In one embodiment the data items also included: today's range, market cap, average volume, price/earnings ratio, price/sales ratio, 1Y target, and EPS, although other embodiments may use a list having different items.

Panel 24 is shown with three links labeled with the headlines Topic 1, Topic 2, and Topic 3 (it will be appreciated that the illustrated headlines are symbolic and in actual embodiments will appear as a lede, such as “XYZ Corp. announces earnings”). A user can click on one of the links to launch another web page with a more elaborate account of the news mentioned in the headline. The web page may be provided by one or more of the financial news servers 118(1) through 118(n) of FIG. 1, although in some cases the page may be provided from common server 16. After reviewing this news account, the user can return to the web page shown in FIG. 3.

The screen of FIG. 3 is a template for displaying a single category of financial, analytic information. This screen shows one way of providing information and accepting user input for each of a number of financial categories (categories of analytic information). Panel 26 has a header marked “CATEGORY i” indicating the i^{th} category of information. As an example, this category may be market capitalization. Text field 26A gives a definition of the current financial category and an explanation of the usefulness of that category in evaluating a security.

As explained in text field 26C, a user can obtain more information relating to this financial category by using link 26B (by clicking with a mouse or by touching a touchscreen). Link 26B will launch another web page having a much more elaborate explanation of the current financial category than can be provided in the limited space allocated for text field 26A This other web page can itself provide links to additional sources, such as SEC filings.

The web page launched by link 26B can be provided through one or more of the financial news servers 118(1) through 118(n) of FIG. 1, although in some embodiments this web page can be provided from common server 116 or from local processor 10.

User input is sought under step ST9 of FIG. 1 by means of input panel 28 of FIG. 3. The user can operate virtual slider 28A to set a confidence score (categorical score) anywhere between zero up to 99% by clicking and dragging the slider button. For a touchscreen, this slider 28A can be moved with a finger. Alternatively, the user can click on input box 28B and type in the confidence score, which will simultaneously cause the slider 28A to move accordingly.

This confidence score is the user's reaction to the information provided by panels 21, 22 and 24, as well as any additional information gathered by using link 26B. Assuming the user just reviewed information about market capitalization, the user may come away with a relatively high (low) level of confidence and will therefore register a relatively high (low) score for this security with respect to market capitalization. In FIG. 3 the user has entered a moderately low confidence score of 40%.

In response to the foregoing entry of a confidence score, the system will update the list of financial categories appearing in column 30. These categories are divided into five classes; namely, Valuation, Income Statement, Balance Sheet, Cash Flow, and Other, although other embodiments may have classes that differ in name, substance or number. In particular the class Other will not appear in the shortened list. These classes are marked by headers 30A through 30E over panels 32A through 32E, which panels will display one or more categorical scores. For example, the first item in panel 32A is identified symbolically as “Category 1 xx %.” Going with the foregoing entry of a 40% confidence score for market capitalization, “Category 1 xx %” may actually be presented as “Market Capitalization 40%.” If no score has been entered for a specific financial category the unscored item may be presented as, for example, “Net Income/Loss —”.

For the full list, the categories will be as follows (the subset used by the shortened list being marked with an asterisk):

VALUATION

Market Capitalization*

Price to Sales Ratio

Price to Earnings Ratio

INCOME STATEMENT

Revenue*

Cost of Sales

Gross Margins/Gross Profit

Selling, General and Administrative

Operating Gain/Loss

Net Income/Loss*

BALANCE SHEET

Cash*

Inventory

Short-Term Debt*

Long-Term Debt*

CASH FLOW STATEMENT

Cash Flow*

OTHER IMPORTANT CONSIDERATIONS

Shares Held by Insiders

Insider Buys/Calls

Institutional Ownership

Shares Short

SEC Filings

Chart

Technical Analysis

Management

Investor Conference Calls

Press Releases/Earnings Reports

The user may by use either next link 34 or previous link 36 to advance to a succeeding screen, which will again use the same template of FIG. 3 but now with respect to a different financial category. If the user is at the i^{th} category, link 34 will change the screen of FIG. 3 to correspond to the next category (Category i+1). If the user is already at the last category (Category e of panel 32E) link 34 will be replaced with a View Score link, which is equivalent to link 38, which will be described further hereinafter.

Basically, using link 34 will cause the system to branch through step ST10 and increment to the next category at step ST11 of FIG. 2. The “next” category will depend on whether the user has chosen the full or shortened list in step ST6. For the full list the system will sequence through every category, but for the short list some categories will be skipped.

Link 36 can be used to change the screen of FIG. 3 to correspond to the previous category (Category i−1), again executing steps of ST10 and ST11 of FIG. 2. If the user is currently at the first category (Category 1 of panel 32A) link 34 will be disabled.

In some cases the user will execute link 34 or 36 without having registered a score in panel 28. In that case the system will automatically register a default score of 50%.

The user may proceed through the list of financial categories in column 30 with the individual scores in column 30 being updated to the latest scores in response to each entry of a score by the user. To give the user a simple visual overview of the scoring, each of the financial categories in panels 32A through 32E will be colored as follows: (1) red for scores below 50%; (2) green for scores above 50%; and (3) uncolored (black or gray) for scores of 50%. Virtual slider 28A will be colored in the same way, based on the score indicated by the slider.

Local processor 10 will be running a JAVA script provided by the common server 16. This script allows storage in processor 10 of the successive categorical scores from each of the successive screens represented by the common template of FIG. 3.

At some point in the scoring process, the user may wish to change between the full or shortened list (change list size by issuing a list size signal). Button 46 may be used for that purpose and as shown in FIG. 2 the system will branch from step ST10 to step ST6. As a result the initial subset of financial categories will be replaced with a different subset. If the user opts to switch from the shortened to the full list, the scores entered for the shortened list will be transferred over for use in the full list.

The user is given other choices on the screen of FIG. 3. If the user has registered through step ST3 of FIG. 2, button 42 may be used to review, edit or update the user's profile (name, address, billing information, password, e-mail, user's preferences, and other settings, all implemented through step ST15 of FIG. 2). Registered users can also log out with button 44 so that others cannot access the user's private information.

In addition, registered users can save the scores recently entered in a session by using button 40 to save these scores at common server 16, although in some embodiments scores will be saved at local processor 10. Furthermore, a user (registered or unregistered) may use button 48 to cease work on the current security and select a new security (indicated in FIG. 2 as a jump from step ST10 to step ST5), although a registered user ought to first save the current scores using button 40.

Panel 45 is reserved for advertisements or other commercial or public service messages.

At any time while using one of the screens of FIG. 3, the user may use link 38 to obtain an overall score, even if the user has not scored all the financial categories in column 30. Button 38 leads to step ST12 where the user is asked to waive liability for any gains or losses related to the use of the web site or any of its features, and to acknowledge that the web site is only for educational assistance and that all investment decisions remain the responsibility of the user. If the user does not agree, the only option is to start again at step ST5. If agreement is indicated by using, for example, a checkbox, the user is allowed to proceed to step ST13 where an overall score is calculated.

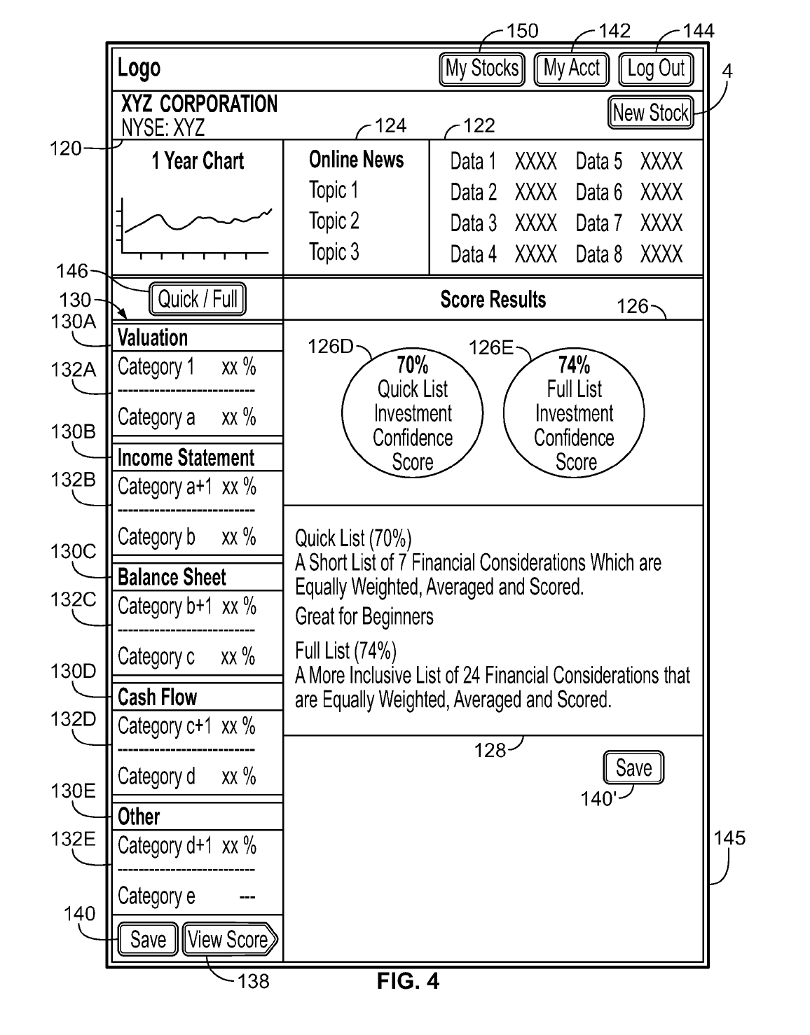

Step ST13 launches the screen shown in FIG. 4. The material displayed on the left and the top of this screen is essentially the same as previously illustrated in FIG. 3. Components corresponding to that previously illustrated in FIG. 3 bear the same reference numerals but increased by 100. In particular, panels 120, 122 and 124 are the same as before. Also column 130 is the same as before, although the individual categorical scores are shown updated by the user's continuing input. In this case the user never reached category e, so no score is given.

Panel 126 is substantially different as indicated by its header SCORE RESULTS. Two simultaneous score targets 126D and 126E are shown with the overall scores obtained for the shortened list (70%) and the full list (74%), respectively. Thus this example assumes that the user has entered scores using both lists (i.e., lists using an initial and different subset of financial categories).

In one embodiment the overall score for the full list is obtained by using all the categorical scores, while the overall score for the shortened list is obtained by using a predetermined subset of these categorical scores. For both lists the overall score is calculated as the simple average of the categorical scores from the pertinent list (shortened or full list). If for some categories no score was entered by the user (for example Category e in column 130) the system will use a default score of 50%.

Instead of a simple average, some systems may employ a different linear combination such as a weighted average that will give greater significance to certain categorical scores and lesser significance to others. (A summation Σaᵢ sᵢ with a weighting factor aᵢ applied to each score sᵢ.) In still other embodiments, the calculated overall score may be any desired function of the various categorical scores.

The overall scores are calculated by sending the categorical scores stored by the previously mentioned JAVA script from local processor 10 to common server 16. Server 16 performs the actual score calculation and stores it before returning it to local processor 10 (although processor 10 may perform the calculation in some embodiments).

Panel 128 has a brief description of the qualities of the shortened (quick) list and the full list. In this example the shortened list has seven financial categories (considerations) and the full list has twenty four, although a different number of can be used in other embodiments. In addition, some embodiments may use one, three or more lists (e.g. a short, a medium, and a full length list).

At this time a registered user may save the individual and overall scores by using either button 140 or 140′. In response the system will save these scores on common server 16 (FIG. 1), although in other embodiments these scores may be saved on local processor 10.

The user may repeat the foregoing process with a new security by clicking on button 148. A registered user will be sent through step ST4 to step ST5, while an unregistered user will be sent directly to step ST5. The repeated process can lead to a repopulating of the screen of FIG. 4 with new categorical and overall scores for this other security (i.e., successive presentation of overall scores for successive securities).

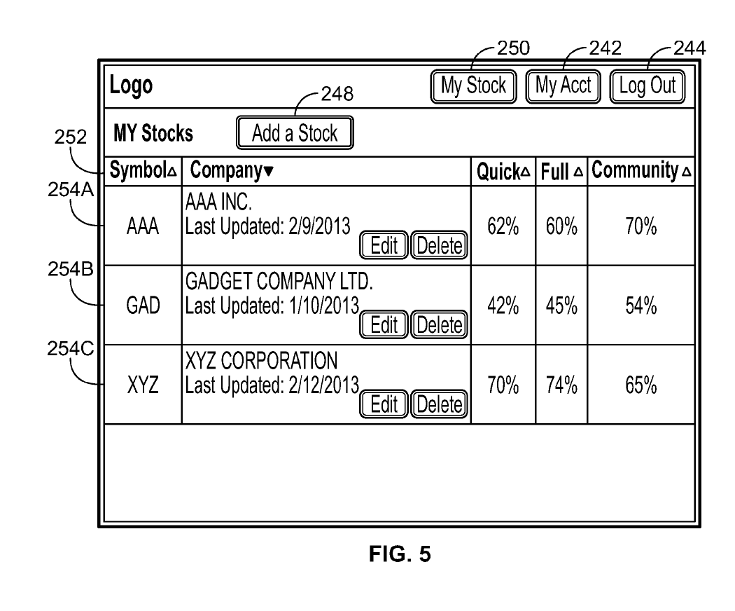

A registered user may also use button 150 (or in the case of the screen of FIG. 3, button 50) to obtain a summary of all securities that have been analyzed by the user. A template of such a summary is shown in FIG. 5, wherein buttons 242, 244 and 248 operate the same as buttons 142, 144 and 148 of FIG. 4. Button 250 is disabled in this screen. This creation of this screen and its associated procedures are implemented by step ST14 of FIG. 2.

The screen of FIG. 5 shows under header 252 three different (successive) securities in rows 254A, 254B and 254C. The first column (heading “Symbol”) gives the ticker symbol, so for example, previously mentioned XYZ Corporation, once the “target” security, is shown with the ticker symbol XYZ in row 254C.

The second column (heading “Company”) gives the company name (e g. “XYZ Corporation” in row 254C) and the date the user last updated scores by using the screen of FIG. 3. Also placed in each of the rows 254A-254C of the second column is a Delete button for deleting a security and an Edit button editing a security's categorical scores using the screen of FIG. 3.

The third and fourth column simultaneously present the latest overall scores produced from the shortened list and the full list.

The last column (heading “Community”) lists averages for each of the three securities (single security averages). The single security averages are obtained by averaging the remote, overall scores of others that were previously stored in common server 16 (FIG. 1). These remote scores of others originate from remote processors 112(1) through 112(n), which have generated overall scores in the same manner as local processor 10. In some embodiments these single security averages will be based on this remote scoring as well as overall scores provided from local processor 10 (FIG. 1) The single security averages may be simple averages or weighted averages that are discounted depending upon the age of individual overall scores.

Thus, the screen of FIG. 5 presents a concise summary of all the user's active securities, listing all the user's overall scores, which can be compared to the prevailing opinion provided as the community averages in the fifth column.

The rows 254A-254C can be sorted by clicking on one of the five triangles associated with each of the five headers. In FIG. 5 the triangle in the second column has been clicked to sort company names in ascending order, which action is indicated by a darkening and inversion of the second triangle.

It is appreciated that various modifications may be implemented with respect to the above described embodiments. The foregoing screens can be reorganized in various ways. In some cases the screens may be divided into several screens. Alternatively some screens can be combined into a single screen. Also the foregoing flowchart shows steps occurring in a particular sequence, but in other embodiments the steps can be reordered or supplemented. Furthermore some of the steps can be eliminated in some cases. Also, the various steps can be executed on a local processor, a common server, or on some other processing means. Also, some embodiments may include additional features such as a blog, a user bulletin board, or a list of investment recommendations made by the system operator.

Obviously, many modifications and variations of the present invention are possible in light of the above teachings. It is therefore to be understood that within the scope of the appended claims, the invention may be practiced otherwise than as specifically described.

1. A system for facilitating self-learning by a user comprising:
a user interface generator that:
(a) presents a request for the user to identify a target security; and
(b) successively presents for a plurality of financial categories (i) information about successive ones of said plurality of financial categories, and (ii) a request for a user to choose for successive ones of said plurality of categories a plurality of categorical scores, said user interface generator comprising:
a processing engine for calculating an overall score for said target security based on said plurality of categorical scores.

2. A system according to claim 1 wherein said processing engine is operable to calculate said overall score using a linear combination of said plurality of categorical scores.

3. A system according to claim 1 wherein said user interface generator is operable to present a list of said plurality of categories together with the latest ones of said plurality of categorical scores.

4. A system according to claim 3 adapted to communicate with a financial news server, said user interface generator being operable to present information derived from said financial news server.

5. A system according to claim 1 wherein said user interface generator is operable to present a request to choose a list size designating an initial subset of said plurality of categories available for scoring.

6. A system according to claim 5 wherein said user interface generator is operable to present an option to change the list size in order to change scoring to a different subset of said plurality of categories.

7. A system according to claim 6 wherein said processing engine is operable to calculate the overall score for the initial and the different subset of said plurality of categories for simultaneous presentation by said user interface generator.

8. A system according to claim 1 wherein the target security comprises a plurality of successive securities, said user interface generator being repetitively operable to successively present the overall score for the plurality of successive securities.

9. A system according to claim 1 wherein the target security comprises a plurality of successive securities, said user interface generator being operable to simultaneously present the overall score for the plurality of successive securities.

10. A system for facilitating self-learning by a user and for exchanging information over a network, the system comprising:
a local user interface operable to allow user selection of a target security; and
a processing arrangement including a common server and local processor both coupled to the network, said local processor being connected to said local user interface, said processing arrangement being operable to transmit for display at said local user interface successive screens regarding a plurality of categories of analytic information, the successive screens presenting successive scoring requests in order to assemble a plurality of categorical scores for said plurality of categories, said processing arrangement being operable to calculate for display at said local user interface an overall score for said target security based on said plurality of categorical scores.

11. A system according to claim 10 wherein said common server is operable to correlate securities by company name and ticker symbol, said local user interface being operable to send over the network to said common server a query regarding either company name or ticker symbol, said common server being operable to reply to the query by returning information correlating company name and ticker symbol.

12. A system according to claim 10 wherein said common server is operable to store the overall score.

13. A system according to claim 10 comprising
a plurality of remote interfaces for transmitting information to said common server corresponding to one or more remote scores for one or more chosen securities, said common server being adapted to store (a) said one or more remote scores, and (b) the overall score.

14. A system according to claim 13 wherein said common server is operable to calculate one or more single security averages using polling based on at least said one or more remote scores for said one or more chosen securities of said plurality of remote interfaces, said processing arrangement being operable to transmit for display on said local user interface target polling information corresponding to that one of said one or more single security averages corresponding to said target security, said local user interface being operable to display said target polling information simultaneously with said overall score.

15. A system according to claim 14, wherein said local user interface is operable to transmit a list size signal corresponding to a list length for establishing which of said plurality of categories will be available at said local user interface, said local user interface being operable to change the list size signal to correspond to successively selected ones of a plurality of list lengths, said processing arrangement being operable to calculate for simultaneously display at the local user interface the overall score for each of the selected ones of the plurality of list lengths.

16. A system according to claim 15 wherein the target security comprises a plurality of successive securities, said processing arrangement being operable to simultaneously display at the local user interface (a) the overall score for each of the plurality of successive securities, and (b) those of said one or more single security averages calculated at said common server and corresponding to said plurality of successive securities.

17. A method for facilitating self-learning by a user and employing a user interface with display, said method comprising the steps of:
allowing user selection of a target security through said user interface;
displaying on said display successive screens regarding a successive plurality of categories of analytic information, the successive screens each having information about a current one of said plurality categories;
accepting through said user interface for said plurality categories a plurality of categorical scores; and
calculating and displaying on said display an overall score for said target security based on said plurality of categorical scores.

18. A method according to claim 17 wherein the step of calculating said overall score is performed by using a linear combination of said plurality of categorical scores.

19. A method according to claim 17 wherein the step of displaying on said successive screens is performed by displaying a list of said plurality of categories together with the latest ones of said plurality of categorical scores, which are updated upon acceptance of the next one of said plurality of categorical scores through said user interface.

20. A method according to claim 17 comprising the step of:
specifying a list size corresponding to a list length in order to limit in number said plurality of categories based on said list size.

21. A method according to claim 20 comprising the steps of:
changing the list size to sequentially select different ones of a plurality of list lengths in order to sequentially limit in number said plurality of categories based on the currently selected one of said list lengths; and
calculating and simultaneously displaying the overall score for each of the different ones of the plurality of list lengths.

22. A method according to claim 17 wherein the target security comprises a plurality of successive securities, the step of calculating and displaying being performed by successively displaying on the display the overall score for the plurality of successive securities.

23. A method according to claim 17 wherein the target security comprises a plurality of successive securities, the step of calculating and displaying being performed by simultaneously displaying on the display the overall score for the plurality of successive securities.

24. A method according to claim 17 employing a common server adapted to communicate over the network with a financial news server and said local processor, the method comprising the step of:
transferring information from said financial news server to said local processor via said common server.

25. A method according to claim 24 comprising the step of:
sending over the network to said common server a query regarding either company name or ticker symbol; and
replying to the query via said common server by returning information correlating company name and ticker symbol.

26. A method according to claim 24 employing a plurality of remote interfaces, the method comprising the steps of:
using scoring information originating at the plurality of remote servers to calculate one or more remote scores for one or more chosen securities; and
establishing communications over the network among said common server, said user interface and said plurality of remote interfaces, in order to store on the common server the overall score and said one or more remote scores.

27. A method according to claim 26 comprising the steps of:
calculating at said common server one or more single security averages using polling based on at least said one or more remote scores for said one or more chosen securities; and
downloading to said user interface from said common server and displaying on said display that one of said one or more single security averages corresponding to said target security, while simultaneously displaying said overall score.

28. A system according to claim 27 comprising the steps of:
specifying a list size corresponding to a list length for establishing which of said plurality of categories will be available at said user interface;
changing the list size to correspond to successively selected ones of a plurality of list lengths; and
calculating and simultaneously displaying the overall score for each of the selected ones of the plurality of list lengths.

29. A method according to claim 28 wherein the target security comprises a plurality of successive securities, the method comprising the steps of:
simultaneously displaying on the display (a) the overall score for the plurality of successive securities, and (b) those of said one or more single security averages at said common server corresponding to said plurality of successive securities.
